(19) United States
(12) Patent Application Publication
(10) Pub. No.: US 2005/0076013 A1
(43) Pub. Date: Apr. 7, 2005

(54) Context-based contact information retrieval systems and methods

(75) Inventors: David M. Hilbert, San Jose, CA (US); Quan Tu Tran, Atlanta, GA (US); Jonathan J. Trevor, Santa Clara, CA (US); Daniel-Alexander Billsus, San Francisco, CA (US); James E. Vaughan, Sunnyvalle, CA (US)

Correspondence Address: OLIFF & BERRIDGE, PLC, P.O. BOX 19928, ALEXANDRIA, VA, 22320, US

(73) Assignee: FUJI XEROX CO., LTD., Minato-ku (JP)

(21) Appl. No.: 10/674,422

(22) Filed: Oct. 1, 2003

(51) Int. Cl. G06F 17/30

(52) U.S. Cl. 707/3

(57) ABSTRACT

Context-based contact information retrieval systems and methods that automatically extract contact information from a user's context, allow a user to capture, reuse and share personal and organizational contacts in the form of a business card or an audio/video recording, as desired. In various embodiments, contacts are retrieved based on the user's context and are presented in a manner that does not disrupt the user's current task. In various embodiments, the user accesses the details of the contacts with a single interaction. In various embodiments, the systems and methods monitor the user's current context and check for matches. The systems and methods then assign a score to each match and unobtrusively present at least some of the matches to the user based on the assigned score.

### BACKGROUND OF THE INVENTION

1. Field of Invention

This invention relates to automatic information retrieval based on the content of a user's context.

2. Description of Related Art

Contact information retrieval systems, such as rolodexes, address lists, directories, contact databases, relationship management softwares and the like, commonly require a user to interrupt the current task to look up contact information, such as a contact name or address. A typical contact directory or database will be accessed by a user if the user suspects that an organization or a person is related to the task the user is currently performing. The user will then interrupt the user's task and use the contact directory to access the needed information.

Furthermore, the user may not think of other contacts because the user doesn't realize or remember that the user has a contact that is relevant, or that a colleague of the user has a relevant contact. Prior work related to this invention can be broadly categorized into three categories: contact systems, content-based inference engines, and just-in-time retrieval agents.

Contact systems include Ricoh's Innovation™ guestbook kiosk, business card scanners and electronic rolodexes, such as CardScan™, BizCard Reader™, and Microsoft Outlook™, as well as contact/relationship management tools such as GoldMine™, TeleMagic™, Maximizer™ and Act™. To obtain contact information using such contact systems, users must manually search lists of known contacts or enter names.

Content-based inference engines are commonly used in recommender systems, match-makers, and knowledge managements systems. AnswerGarden2™ and ReferralWeb™ are systems that allow users to manually locate others with specific expertise, or to explore inter-connections between people in social networks. Match-maker systems, such as Yenta™, can help users locate potentially relevant contacts based on detailed profiles provided by users. The inference engines used in enterprise knowledge management systems, offered by companies such as Verity™ and Autonomy™, can use data about users' interests, assigned tasks, and expertise to locate potentially related information.

Just-in-time retrieval agents do not require the user to manually formulate queries. Remembrance Agent™, Margin Notes™, Watson™, Suitor™, Letizia™ and Xlibris™ are all examples of systems that include just-in-time retrieval agents that recommend content such as web pages or text documents. Jimminy™, a wearable information system, receives information from a sensor informing it that a certain person is in the same room. If this person happens to be in the user's personal rolodex, Jimminy™ displays their name proactively.

### SUMMARY OF THE INVENTION

However, none of the systems described above retrieves contacts based on the user's context, and none proactively recommend contacts. Known contact retrieval systems result in a loss of time, because the user has to interrupt the task the user is performing and start querying information sources for possible contact information. Furthermore, since such contact retrieval systems also often do not produce desired results, a system which can produce reliable contact information without needing to interrupt the user's task would be highly useful. Similarly, the ability to acquire relevant contact information while the user is performing another task is highly desirable.

This invention provides systems and methods for analyzing a user's context to identify possible relevant contact information.

This invention separately provides systems and methods for identifying possible relevant contact information based on a user's context.

This invention separately provides systems, methods and graphical user interfaces for displaying identified possible relevant contacts to a user without interrupting the user's workflow.

In various exemplary embodiments of systems and methods according to this invention, an information retrieval system includes a database that stores contact information, a contact information retrieval circuit, routine or application that analyzes the user's context and that retrieves contact information, and a display circuit, routine or application that unobtrusively displays the retrieved contact information.

In various exemplary embodiments, contact information relevant to a user is automatically retrieved based on the user's context. This approach increases efficiency, collaboration, and productivity. Various exemplary embodiments of systems and methods according to this invention improve the user's ability to capture, reuse and share personal and organizational contacts that are directly relevant to the task that the user is performing. This has the added benefit of supporting serendipity, or promoting the discovery of new contacts that the user may not have thought of, based on the context of the document the user is currently viewing.

In various exemplary embodiments of systems and methods according to this invention, a database is queried based on the content of the document currently being viewed by the user, relevant contact information is retrieved, and, without distracting the user from their current task, these contacts are then unobtrusively presented in a manner that does not disrupt the user's task, but which also allows the user to access the details of the contacts with, for example, a single interaction.

In various exemplary embodiments of systems and methods according to this invention, an information retrieval apparatus includes an information gathering circuit, routine or application that inputs contact information, a database that stores the contact information, an information monitoring and analysis circuit, routine or application and a data output circuit, routine or application that notifies the user of relevant contact information. The information gathering circuit, routine or application can be implemented using a computer with at least one of a scanner or a camera, and/or a keyboard, a touch-screen or other input circuit, routine or application that may serve as an audio/video guestbook. The information gathering circuit, routine or application may, for example, be located in a reception area. In various exemplary embodiments of systems and methods according to this invention, the reception area may be the reception area of a company building, a hotel or a convention hall. The information entered or recorded into the information gathering circuit, routine or application is then stored in a database. In various exemplary embodiments of systems and methods according to this invention, the database is located at a remote location and connected to the information gathering circuit, routine or application via a link or a network.

In various exemplary embodiments of systems and methods according to this invention, the information retrieval apparatus includes one or both of an information monitoring circuit, routine or application and an information analysis circuit, routine or application which allow the information contained in the user's context to be continuously monitored and analyzed. In various exemplary embodiments of systems and methods according to this invention, the information retrieval apparatus includes a data output circuit, routine or application that notifies the user of relevant information by unobtrusively bringing relevant contact information to the user's attention.

Various exemplary embodiments of systems and methods according to this invention include populating a contact database with contact information, analyzing a user's context, and displaying relevant contact information to the user. Populating the contact database is performed by capturing contact information, such as a business card, an email address, a telephone number, an address, an audio/video recording of a person's face and voice, and the like. The contact information is then transmitted to and stored in the contact database via a link or a network. In various exemplary embodiments, analyzing the user's context include determining possible matches between the user's current context and the contact information stored in the contact information database. Once matches are determined, the relevant contact information is brought to the user's attention. In various exemplary embodiments, the relevant contact information is displayed as a supplementary toolbar on the user's screen. The contact information can then be readily accessed by the user simply by clicking on the toolbar.

These and other features and advantages of this invention are described in, or are apparent from, the following detailed description of various exemplary embodiments of the systems and methods according to this invention.

### BRIEF DESCRIPTION OF THE DRAWINGS

Various exemplary embodiments of systems and methods according to this invention will be described in detail with reference to the following figures, wherein:

FIG. 1 is a flowchart outlining an exemplary embodiment of a method for supplying contact information data according to this invention;

FIG. 2 is a display illustrating one exemplary embodiment of a system usable to input contact information data according to this invention;

FIG. 3 is a flowchart outlining an exemplary embodiment of a method for retrieving context-based contact information according to this invention;

FIGS. 4 and 5 are a flowchart outlining in greater detail one exemplary embodiment of a method for monitoring information according to this invention;

FIG. 6 is a flowchart outlining in greater detail one exemplary embodiment of a method for analyzing the analysis list according to this invention;

FIG. 7 is a flowchart outlining in greater detail one exemplary embodiment of a method for output matching information according to this invention;

FIG. 8 illustrates a graphical user interface of an application to which has been added a first exemplary embodiment of a matching information display according to this invention;

FIG. 9 illustrates a graphical user interface of an application to which has been added a second exemplary embodiment of a matching information display according to this invention;

FIG. 10 illustrates one exemplary embodiment of a graphical user interface usable to display matching contact information according to this invention; and

FIG. 11 is a block diagram illustrating one exemplary embodiment of a context-based contact information retrieval system according to this invention.

### DETAILED DESCRIPTION OF EXEMPLARY EMBODIMENTS

In various exemplary embodiments according to this invention, contact information is collected from visitors who are asked to provide their name and organization and answer a few questions. For example, an operator may operate a computer, scan the visitor's business card into a scanner, make an audio and/or video recording of the visitor and/or record the visitor's answers to questions, as discussed below. Alternatively, the visitors may directly scan their business cards into the scanner, make an audio and/or video recording and/or answer various questions at a self-operated input station. In various exemplary embodiments of the systems and methods of this invention, the scanned information, audio/video recording and/or answers to the questions are automatically transmitted and stored in a memory or database connected to the computer or other input circuit, routine or application through a link or a network.

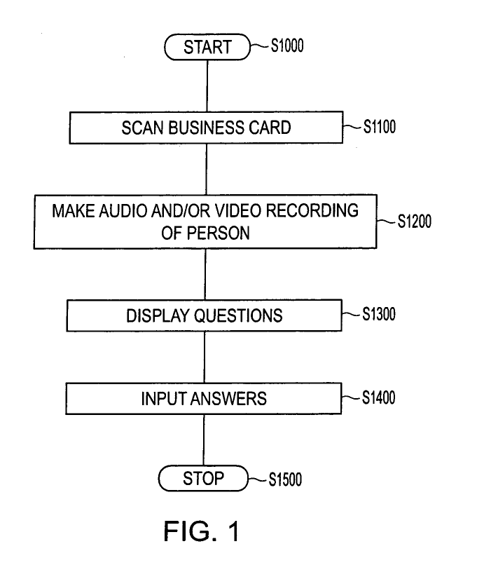

FIG. 1 is a flowchart illustrating an exemplary embodiment of a method for collecting contact information according to this invention. This method can be secured, for example, by an offer to collect contact information from visitors to an office. When an individual proceeds to check-in at a reception area of the office, for example, the individual is invited to scan the individual's business card via the scanner. As shown in FIG. 1, beginning in step S1000, operation continues to step S100, where the individual's business card is scanned. Then, in step S1200, an audio and/or video recording of the visitor is taken. The individual is invited to pronounce the visitor's name in front of a camera which is also linked to the computer. The voice and/or video recording are also stored in the memory or database. Next, in step S1300, questions, such as the visitor's name and/or organization, are displayed or otherwise output to the visitor, such as by audio. The visitor can also be asked to enter the visitor's name, telephone number and address. In step S1400, the visitor inputs the visitor's answers to the displayed questions, for example, by using a keyboard and/or touchscreen. The answers can then be stored in the memory or database. Operation then continues to step S1500, where operation of the method ends. Steps S1000 through S1500 are repeated each time a new visitor arrives.

It should be noted that, in various exemplary embodiments of the systems and methods according to this invention, during step S1100, the email address and/or other electronic identification and/or location information, such as, for example, a uniform resource locator (URL) or a uniform resource identification (URI) associated with the visitor or the visitor's organization, is recognized from the scanned business card and stored in a memory or database. One or more telephone numbers and/or postal addresses associated with the visitor are also recognized and stored in the memory or database. The telephone numbers can include one or more of a personal voice number, a work voice number, a personal facsimile number, a work facsimile number, a mobile number, a pager number or any other known or later-developed type of telephone number.

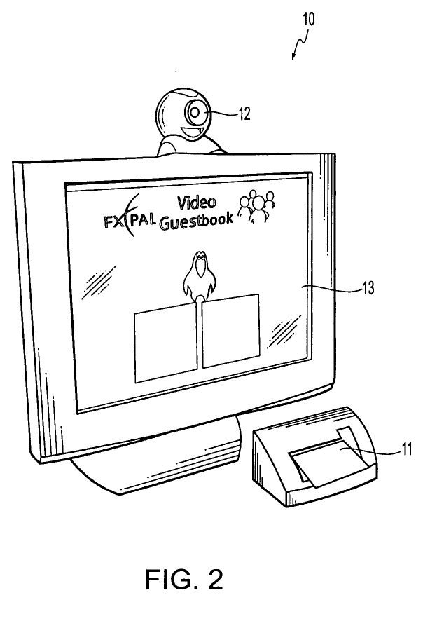

FIG. 2 illustrates one exemplary embodiment of a contact information recording device 10 according to this invention. The contact information recording device 10 includes a business card scanner 11, a camera 12, which may include a microphone, and a display screen 13, which may be a touchscreen.

In various exemplary embodiments of systems and methods according to this invention, the contact information, initially stored in the computer or other input device, is transmitted, such as, for example, immediately or at the end of each day or work period, to the memory or database. This information corresponds to the contact information obtained from the visitor. Once transmitted and stored, this contact information, which comprises additional data, enriches the contact information in the contact information database. The contact information database is accessed, for example, by a computer that is connected to the database via a link or a network. Once a database containing contact information is constituted, then a method for retrieving contact information can be implemented.

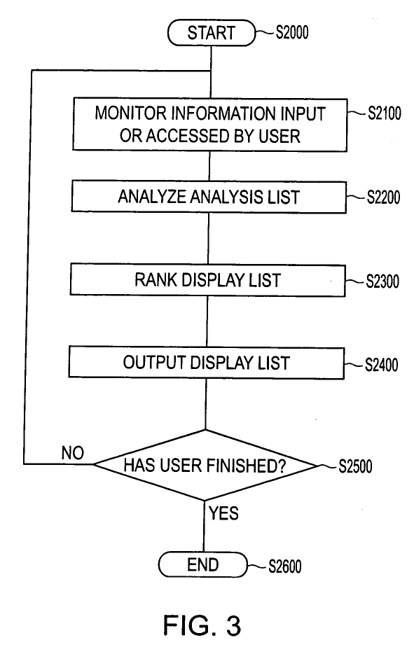

FIG. 3 outlines one exemplary embodiment of a method for retrieving contact information according to this invention. As outlined in FIG. 3, operation of the method begins in step S2000 and continues to step S2100, where the document viewed by the user is monitored. Then, in step S2200, the document or current context of the user is analyzed to identify postal addresses, email and/or other electronic addresses, telephone numbers and/or names of persons or organizations. Next, in step S2300, any identified contact information is ranked. Then, in step S2400, for the highly-ranked contact information, the matching information is output, for example, in the form of an unobtrusive display on the user's computer screen. Next, in step S2500, a determination is made whether the user has finished with the current context. If the user is not finished with the current context, then operation returns to step S2100 and continues to monitor the context currently being viewed by the user. Otherwise, operation proceeds to step S2600, where operation of the method ends.

It should be appreciated that, in step S2400, the identified contacts in the ranked list can be selected for display to the user in any of a number of ways. For example, in various exemplary embodiments, any identified contact having a sufficiently high score is selected for display, regardless of the number of such identified contacts. In various other exemplary embodiments, a give number n of identified contacts from the top of the ranked list are selected for display, regardless of the actual score associated with those n identified contacts. In still other exemplary embodiments, the top n identified contacts are initially selected for display from the top of the ranked list. Then, of the top n selected contacts, only those having a sufficiently high score are actually displayed. In various exemplary embodiments, this is done, for example, by removing from the list of the top n contacts those that do not have a sufficiently high score.

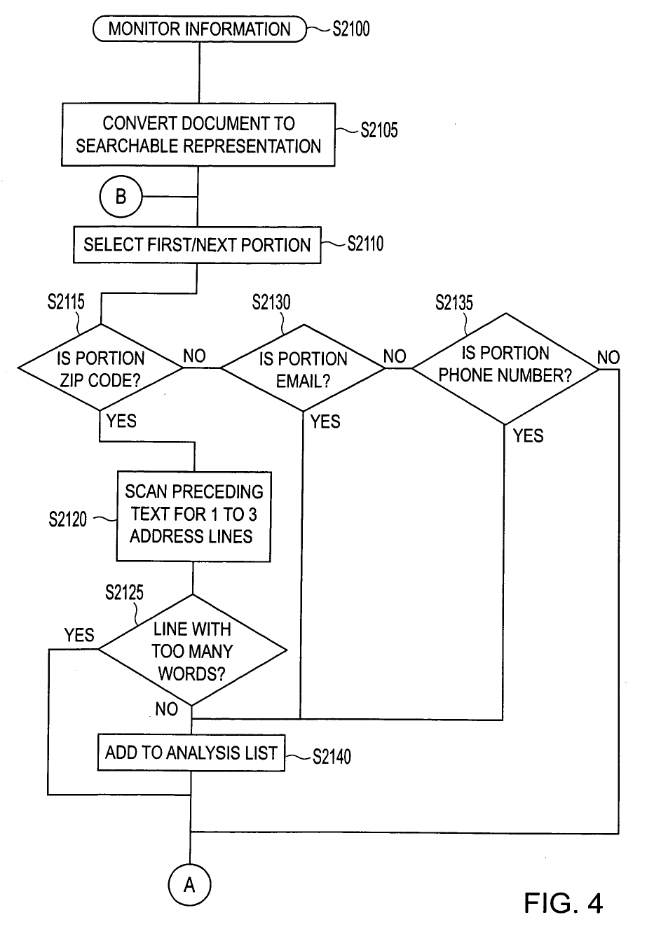

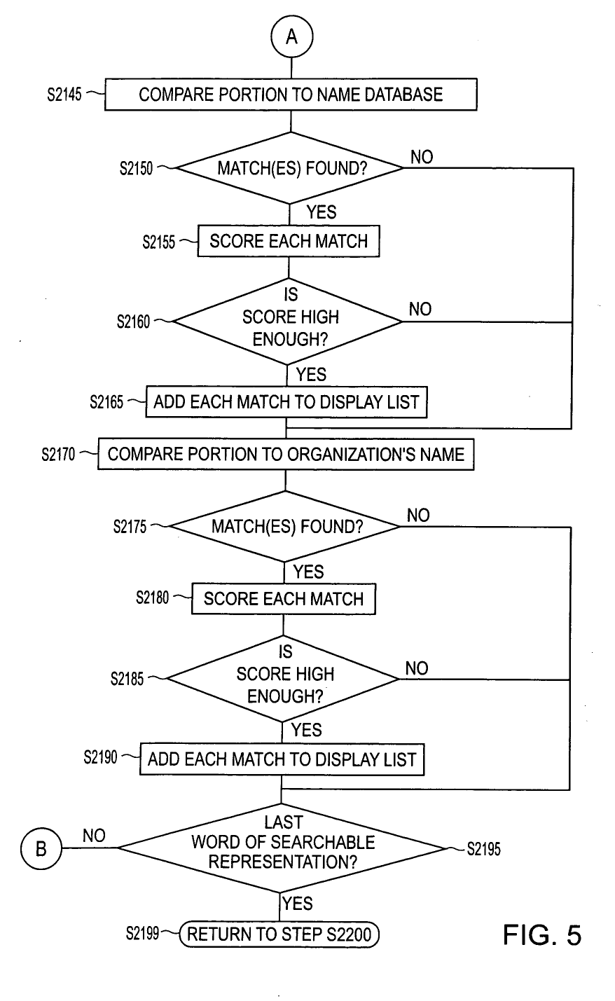

FIGS. 4 and 5 outline in greater detail one exemplary embodiment of the method for monitoring the user's context according to this invention. When a user is viewing a document, such as an email message, a text document or a web page, the document being viewed is monitored. For example, the user's current context is monitored by extracting text, or html text in the case of a web page, from one or more of the pages in the document, and parsing the text to find recognizable information. In various exemplary embodiments of systems and methods according to this invention, there are several types of recognizable information, such as for example, postal addresses, email addresses and telephone numbers.

As shown in FIG. 4, operation of the method begins in step S2100 and continues to step S2105, where the document, or other current context, currently being viewed by the user is converted into a searchable representation. For example, in various exemplary embodiments, the document, or other current context, is parsed into a series of searchable portions, such as, for example, groups of characters separated by blanks. These searchable portions will be also be referred to as groups in the following discussion.

Next, in step S2110, a first or next one of these groups is selected as a current group. Then in step S2115, a determination is made whether the current group is a postal code. In various exemplary embodiments of the systems and methods according to this invention, any five- or nine-digit number, ignoring the dash “-” that may be present in a nine-digit number, is presumed to be a potential postal code. If the current group corresponds to a postal code, operation continues to step S2120. Otherwise, operation jumps to step S2130.

In step S2120, one or more information groups that precede the current group that could be a postal code are analyzed. For example, up to three lines preceding a current group that could be a postal code are analyzed, since these lines may represent the remaining part of an address. In some exemplary embodiments, these preceding information groups are temporarily stored, along with the current group that could be a postal code, for example, in a memory of the computer. Next, in step S2125, a determination is made whether these preceding groups correspond to an address. If the number of words present within these preceding groups is greater than a defined limit, which may be related, for example, to an average number of words present in a typical address, then the five- or nine-digit number and the three preceding lines are deleted from memory and operation jumps to step S2145. Otherwise, if the number of words present within the lines is less than or equal to the defined limit, operation continues to step S2140.

It should be noted that, in various exemplary embodiments, for a current group identified as a postal code and address, to determine whether these preceding groups preceding a postal code correspond to an address, a comparison is made between the number of words contained in the lines and a defined limit on the number of words, which may be related, for example, to the number of words present in a typical address, ignoring words such as “Avenue”, “Street”, and the like. Since not every five- or nine-digit number is a postal code and not every postal code is necessarily preceded by the rest of the address, the total number of words is counted.

In contrast, in step S2130, a determination is made whether the current group of characters corresponds to an email address. If the current group of characters corresponds to an email address, operation jumps to step S2140. Otherwise, operation continues to step S2135.

In step S2135, a determination is made whether the current group corresponds to a telephone number. For example, a group in the parsed document that contains a ten-digit number, ignoring any parentheses or dashes that may be used to delineate area code from actual telephone number, is identified. Any group containing a ten-digit number is identified as a possible telephone number. If the current group of characters corresponds to a telephone number, operation continues to step S2140. Otherwise, operation jumps to step S2145.

In step S2140, the current group is a postal code, an email address or a telephone number. Accordingly, if the current group, along with, in various exemplary embodiments, in one or more situations, one or more preceding and/or one or more following groups is a postal code, the set of these preceding groups and the current group, representing the entire address, including the identified postal code, is added to an analysis list for further analysis. In contrast, when the current group is an email address, it should be noted that, in various exemplary embodiments, in step S2140, the part of the email address immediately following the “@” character, i.e., the suffix, may represent a company or organization. In step S2140, this email address, or at least the suffix, is stored in the analysis list for further comparison with the contact information contained in the contact information database. In various exemplary embodiment, in contrast to both of these, when the current group is a telephone number, the telephone number is stored into the analysis list. This telephone number is stored for further comparison with the contact information contained in the contact information database. Operation then continues to step S2145.

In step S2145, the current group is compared to the list of contact person names to determine if it matches at least one contact name in the database. Next, in step S2150, a determination is made whether the current group matches a person's name in the contact information database. If a match is found, then operation continues to step S2155. Otherwise, operation jumps to step S2170. In step S2155, a score is assigned to the current group based on how well it matches one or more person names in the contact database. Then, in step S2160, a determination is made whether the score assigned to the match is high enough to be relevant to the user currently viewing the context. In various exemplary embodiments, the score is compared to a determined threshold score. If the score is higher than the threshold, the score is considered high enough. If the score is high enough, operation proceeds to step S2165. Otherwise, operation again jumps to step S2170. In step S2165, the matched person's name is stored in a display list.

In step S2170, the current group is compared to organization names in the contact database. Then, in step S2175, a determination is made whether the current group matches one or more organization names that are present in the contact information database. If the current group matches an organization's name in the contact database, operation continues to step S2180. Otherwise, operation jumps to step S2195.

In step S2180, a score is assigned to the current group based on how well it matches the organization's name. Then, in step S2185, a determination is made whether the score assigned to the match is high enough to be relevant to the user currently viewing the context. If the score is high enough, operation proceeds to step S2190. Otherwise, operation jumps to step S2195. In step S2190, the matched organization's name is stored in the display list.

In step S2195, a determination is made whether the current group being analyzed is the last group. If there are more groups left to be analyzed, operation returns to step S2110. Otherwise, operation continues to step S2199, where operation returns to step S2200.

It should be appreciated that, in various other exemplary embodiments, in addition to or in place of step S2145, rather than comparing each group to the names of the contacts and/or their organizations that are present in the database, each contact (i.e., person) name and/or each organization name present in the database can be selected in turn and compared to the content of the user's current context to find matches between a contact name or an organization name present in the database and a text string in the user's current context. For example, one exemplary embodiment of comparing the names in the database to the user's current context includes creating a representation of a selected person or organization name that is present in the database and then querying the user's current context using that representation. In various exemplary embodiments, that representation is merely the selected person or organization name. In various other exemplary embodiments, that representation can be a regular expression derived from the selected person or organization name.

In other exemplary embodiments, since it is likely that explicitly searching for known names leads to more accurate results, and since the number of known names in the contact information database is limited, this approach is feasible and efficient enough for real-time matching. In various exemplary embodiments, matches of the form [FirstName LastName] or [LastName, Firstname], are scored highly. In other exemplary embodiments, the score is increased slightly based on the number of times the names are found in the document. Matches of the form [Initial LastName] [LastName, Initial] receive lower scores. An organization match begins when the first word of an organization is found in the document. The score is based on the number of remaining words in the organization name that are found near the first word, ignoring common words, such as “Inc”, “Co”, and the like.

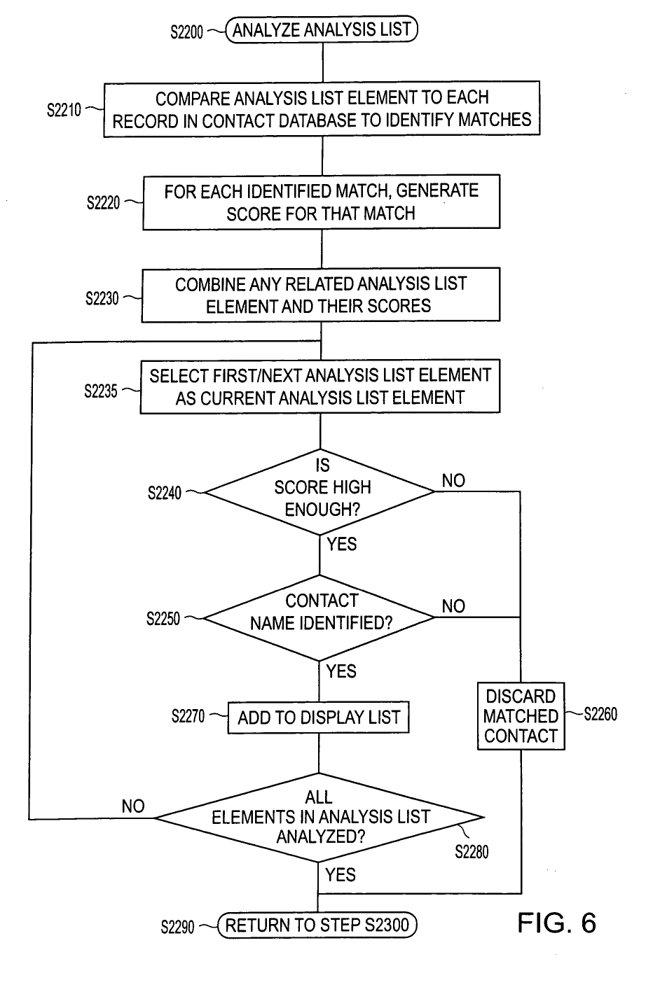

FIG. 6 outlines in greater detail one exemplary embodiment of systems and methods according to this invention for analyzing the analysis list. As shown in FIG. 6, operation of the method begins in step S2200 and continues to S2210, where each analysis list element, in turn, is compared to each element present in the contact information database, and any matches between a particular analysis list element and the contact information database element are identified. In various exemplary embodiments of the systems and methods of this invention, depending on whether a given analysis list element is a postal code, an email address or a telephone number, that analysis list element is compared with each postal code, each email address or each telephone number, respectively, present in the contact information database. Next, in step S2220, when a comparison between an analysis list element and one or more contact information database element results in a match, a score is assigned to the matched analysis list element. If an analysis list element does not match any of the contact information database elements, then a zero score is assigned to the unmatched analysis list element. Operation then continues to step S2230.

It should be noted that, in various exemplary embodiments of systems and methods according to this invention, the score assigned to an analysis list element is based on the quality of match between the analysis list element and the contact information database elements. For instance, in the case of a postal code, a high score is given to the analysis list element if every word of the address in that analysis list element is present in a matching address from the contact information database, ignoring common words such as “Avenue”, “Street”, “Road”, or their contractions and the like. A partial score is given if only parts of the address in that analysis list element are present in a matching address from the contact information database or vice versa. A lower score is given to the analysis list element if only the postal code matches an address from the contact information database.

It should also be noted that, in various exemplary embodiments of systems and methods according to this invention, in the case of an analysis list element that is identified as an email address, the contact information database is analyzed for people with the same email or organizations with the same suffix as the email address present in that element of the analysis list. If a determination is made that the email address present in that element of the analysis list does not exactly match any email address in the contact information database, then a determination is also made whether the email address present in that element of the analysis list partially matches any email address in the contact information database. If a determination is made that the email address present in that element of the analysis list completely matches an email address from the contact information database, then the matched analysis list element is assigned a high score. A partial score is given to that matched analysis list element if only the suffix, or a portion of the suffix, matches one or several email addresses from the contact information database. If a determination is made that the email address present in that element of the analysis list does not match any email address from the contact information database, then a zero score is assigned to that email address.

It should further be noted that, in various exemplary embodiments of systems and methods according to this invention, in the case of a telephone or facsimile number, the contact information database is analyzed for people or organizations with the same telephone or facsimile number as a telephone or facsimile number present in that element of the analysis list.

If a determination is made that a telephone number present in that element of the analysis list matches a telephone number from the contact information database, then a score is assigned to the matching analysis list element containing that telephone number. In various exemplary embodiments of systems and methods according to this invention, the score is based on whether that analysis list element matches a personal voice telephone number, a work voice telephone number, a mobile telephone number, a personal or work facsimile telephone number or a pager number or some other type of telephone number. In various exemplary embodiments, if the matched analysis list element containing that telephone number is matched to a voice number in the contact information database, a higher score is given to that analysis list element than if that analysis list element matches, for instance, a facsimile number.

If a determination is made that the telephone number present in that analysis list element does not match any telephone number in the contact information database, then a zero score is assigned to that analysis list element.

In step S2230, for at least some analysis list elements that are related to each other, a combined score is generated for any such analysis list element. In various exemplary embodiments of systems and methods according to this invention, the combined score for such analysis list elements is based on the number of matches identified between such analysis list elements in the analysis list and the contact information database. For instance, if a postal code is present in an analysis list element and is matched to a particular record of a postal code in the contact information database, and an email address is also matched to an email address in the same or related record of the contact information database, then the score of these two elements (postal code and email address) is combined and associated with each such analysis list element. In various exemplary embodiments, the analysis list elements themselves can be combined.

Next, in steps S2235, a first or next analysis list element is selected as a current analysis list element. Then, in step S2240, the combined score of the current analysis list element is compared to a defined score threshold. If the combined score is above the defined threshold, operation continues to step S2250. Otherwise, operation jumps to step S2260. In step 2250, the current analysis list element is analyzed to determine if the current analysis list element contains a person's or organization's name. If the scored analysis list element does not contain a person's or organization's name, operation again continues to step S2260. Otherwise, if the current analysis list element contains a person's or organization's name, operation jumps to step S2270.

In step S2260, the current analysis list element is discarded. Operation then jumps to step S2280. In contrast, in step S2270, the current analysis list element is added to a display list. The display list contains contact names to be displayed to the user. In various exemplary embodiments of the systems and methods according to this invention, the display list elements are ranked from most relevant entry, i.e., highest score, to least relevant entry, i.e., lowest score, of the elements added to the display list. Next, in step S2280, a determination is made whether there are any unselected elements in the analysis list to be analyzed. If there are any elements in the analysis list that have not been selected, operation returns to S2235. Otherwise, operation continues to step S2290, where operation returns to step S2300.

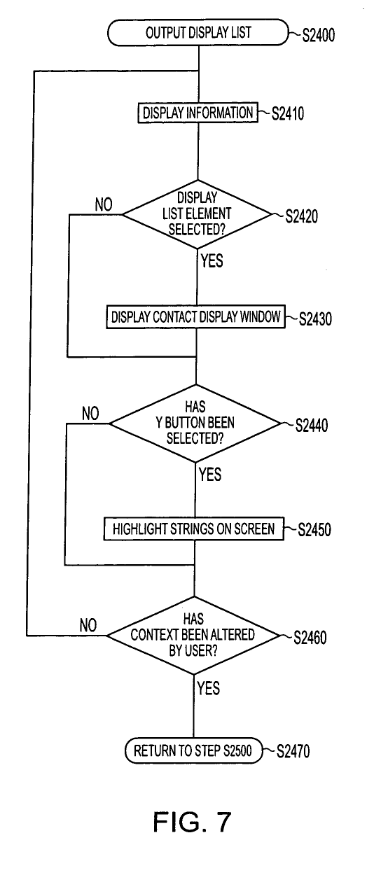

FIG. 7 is a flowchart outlining in greater detail one exemplary embodiment of the method for outputting the display list according to this invention. As shown in FIG. 7, operation of the method begins in step S2400, and continues to step S2410, where the display list elements are displayed to the user. For example, in various exemplary embodiments, the display list elements are shown as elements of a toolbar of a graphical user interface currently being used by the user. The toolbar does not mask any useful or important part of the computer screen, and lists the names of the relevant contacts. Then, in step S2420, a determination is made whether the user has selected a displayed display list element, such as, for example, by selecting one of the display list elements contained in the toolbar displayed as part of the graphical user interface of the program the user is interacting with. If so, operation continues to step S2430. Otherwise, operation jumps to step S2440. In step S2430, a window is created displaying the contact information of the selected display list element. Then, in step S2440, a determination is made whether the user wants to highlight the display list element in the original context currently being viewed. If so, then operation continues to step S2450. Otherwise, operation jumps to step S2460. In step S2450, the selected display list element is highlighted in the original context currently being viewed in order to clarify to the user, for instance, the circumstances under which that specific display list element is mentioned in the context currently being viewed. Then, in step S2460, a determination is made whether the user has altered the context. If not, operation returns to step S2410. Otherwise, operation continues to step S2470, where operation of the method returns to step S2500.

In various exemplary embodiments, as long as the user is viewing a context, the context-based contact retrieval method performs its function. The method ends when the user shuts off the current context.

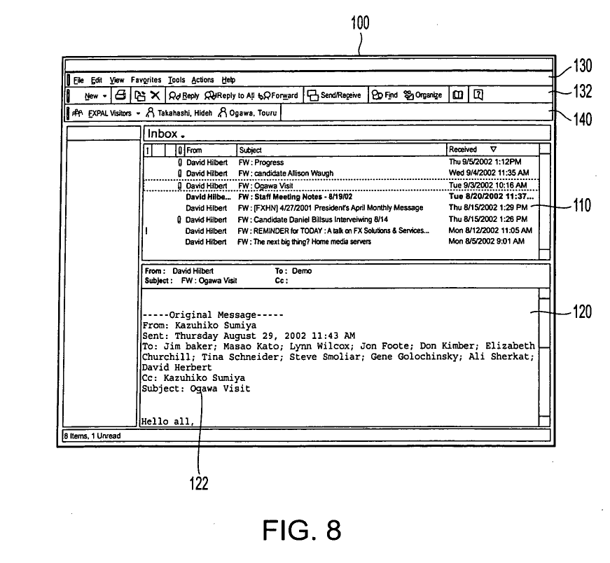

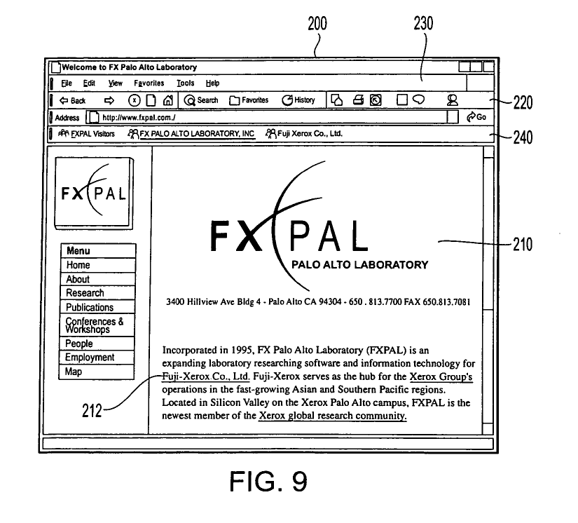

The display list element is displayed in a separate window, or as a graphical user interface widget, such as, for example, a toolbar, as illustrated, for instance, in FIGS. 8 and 9, which illustrate various exemplary embodiments of a graphical user interface that incorporates an unobtrusive display of contact information according to this invention. In these exemplary embodiments, the displayed contact information is in the form of a toolbar appearing unobtrusively on the screen of the user or an image of the contact.

FIG. 8 illustrates a situation where the user is viewing an email. As shown in FIG. 8, the email application window 100 includes an email message list portion 110, an email body portion 120, an application toolbar 130, an email editing toolbar 132 and a contact information display toolbar 140. The email message list portion 110 shows a list of email messages currently available to the user. The email body portion 120 displays the contents of a selected email message. The information displayed in the email body portion 120 is monitored and/or analyzed by the contact retrieval system to generate the display list, as explained above. In various exemplary embodiments of the systems and methods according to this invention, the display list is displayed to the user in the contact information display toolbar 140. In the specific example illustrated in FIG. 8, the contact information displayed in the contact information display toolbar 140 results from the presence, in the email message (the user's current context) that is displayed to the user in the email body portion 120, of a name 122. The name 122 is compared to the contact information database and the contact information is displayed in the contact information display toolbar 140.

FIG. 9 illustrates a situation where the user is viewing a web page. As shown in FIG. 9, the web page application window 200 includes a web page display window 210 that displays the contents of a selected web page to the user, a web page editing toolbar 220, a web page application toolbar 230 and a contact information display toolbar 240. The web page currently viewed by the user is shown in the web page window 210. The information displayed in the web page 210 is monitored by the contact retrieval system to generate the display list, as explained above. In various exemplary embodiments of the systems and methods according to this invention, the display list is displayed to the user in the contact information display toolbar 240. In the specific example illustrated in FIG. 9, the contact information displayed in the contact information display toolbar 240 results from the presence, in the web page currently being viewed by the user (the user's current context) via the web page window 210, of a company name 212. The company name 212 is compared to the contact information database and the full contact information is displayed in the contact information display toolbar 240.

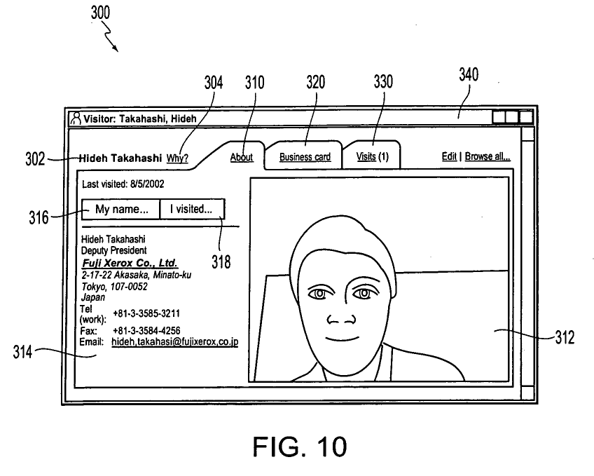

In response to selecting one of the contact displayed in the contact information tool bar 140 or 240 shown in FIG. 8 or FIG. 9, respectively, a window displaying the contact information stored in the database for that selected contact is displayed to the user. FIG. 10 shows one exemplary embodiment of such a contact display window. As shown in FIG. 10, the stored contact information, including an image of the contact, is shown in the contact display window 300. The contact display window 300 includes a personal information tab 310, a business card tab 320, a visits tab 330 and a name toolbar 340. Personal information of the contact person is displayed within the personal information tab 310, where at least an image of the contact person is displayed in an image portion 312. In various exemplary embodiments, the image portion 312 is used to display a video, rather than merely a still image, of the contact. The name of the person is also displayed in a name portion 302 of the context display window 300. The name of the user is also displayed in a name portion 316. The time and place of the contact person's visit is displayed on a visit portion 318. Other information, such as postal and email addresses and telephone and facsimile numbers is displayed in an information portion 314. In various exemplary embodiments of systems and methods according to this invention, other information is displayed to the user, such as an image of the contact person's business card within the business card tab 320, and/or the type, number and locations of visits made by the contact person within the visits tab 340.

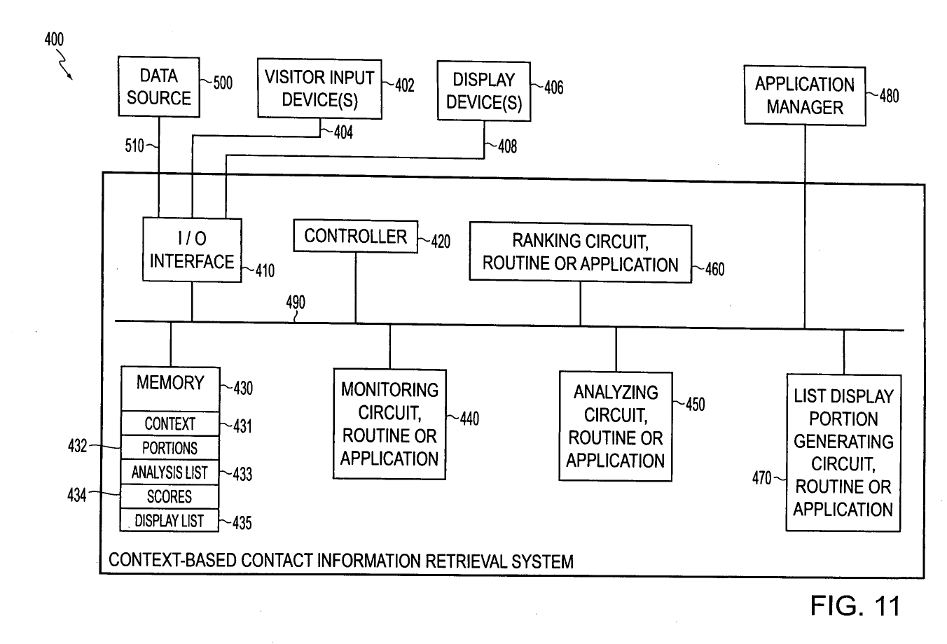

FIG. 11 is a block diagram illustrating one exemplary embodiment of a context-based contact information retrieval system 400 according to this invention. In various exemplary embodiment, the context-based contact information retrieval system includes an input/output (I/O) interface 410, a controller 420, a memory 430, an application manager 480, each interconnected appropriately by one or more control and/or data busses and/or application programming interfaces 490.

The monitoring circuit, routine or application 440 is used to perform parsing of a context being viewed by the user into a searchable representation. The monitoring circuit, routine or application 440 is also used to compare each portion to contact information present in the contact information database, and to store matched contact information in the memory 430. The analyzing circuit, routine or application 450 is used to analyze the information monitored by the use of the monitoring circuit, routine or application 440 in assigning scores to the matched contact information.

The ranking circuit, routine or application 460 is used to rank the matched contact information to be displayed to the user. The list display portion that contains the list of contacts to be presented to the user is generated by the display list generalizing circuit, routine or application 470. The generated display list portion of the matched contact information is output to the application manager 480 to be displayed to the user.

In various exemplary embodiments of systems and methods according to this invention, the memory 430 comprises several memory portions dedicated to different activities of the context-based contact retrieval system 400. Memory portions are allocated in the memory 430, such as, for example, to store the current context in a memory portion 431, the parsed groups or portions in a memory portion 432, an analysis list compiled from the context in a memory portion 433, the scores given to each matched element of the analysis list in a memory portion 434, and the display list in a memory portion 435.

The memory 430 can be implemented using any appropriate combination of alterable, volatile or non-volatile memory or non-alterable, or fixed, memory. The alterable memory, whether volatile or non-volatile, can be implemented using any one or more of static or dynamic RAM, a floppy disk and disk drive, a writable or re-writeable optical disk and disk drive, a hard drive, flash memory or the like. Similarly, the non-alterable or fixed memory can be implemented using any one or more of ROM, PROM, EPROM, EEPROM, an optical ROM disk, such as a CD-ROM or DVD-ROM disk, and disk drive or the like.

As shown in FIG. 11, a data source 500 containing contact information is connected by a link 510 to the input/output interface 410 of the context-based contact information retrieval system 400. A user input device 402, such as a keyboard, a scanner, an audio or a video recorder, controlled by an input/output interface 410, is used by a visitor to input the visitor's contact information. A display device 406, such as, for instance, a computer screen, also controlled by the input/output interface 410, is used by the visitor to view, for instance, any questions that the visitor may have to answer in order to input the visitor's contact information in the data source 500.

The link 510 between the context-based contact retrieval system 400 and the data source 500 can be implemented using any known or later-developed device or system for connecting the contact retrieval system 400 to the data source 520, including a direct cable connection, a connection over a wide area network or a local area network, a connection over an intranet, a connection over the Internet, or a connection over any other distributed processing network or system. In general, each of the connections can be any known or later developed connection system or structure usable to connect the context-based contact retrieval system 400 and the data source 500. Of course, it should be appreciated that the contact information database, rather than being stored in the data source 500, can be stored locally relative to the context-based contact retrieval system 400.

Once the contact information is output to the data source 500, when a user is viewing a context, such as, for instance, an email, a word document or a webpage, the monitoring circuit, routine or application 440, under control of the controller 420, monitors the context being viewed by the user that is stored in the memory portion 431, by breaking the context into separate groups of characters. In various exemplary embodiments, the monitoring circuit, routine or application 440 identifies several different types of portions, for example, postal address, email address and telephone number that are relatable to specific contact information stored in the contact information database. In various exemplary embodiments, the monitoring circuit, routine or application 440 also appellate the group stored in the memory portion as the user's current context evolves, such as, for example, as the user authors a document or the like.

In various exemplary embodiments, the monitoring circuit, routine or application 440 searches the groups obtained from the current context and stored in the memory portion 431 for any five- or nine-digit number. The monitoring circuit, routine or application 440 associates any group containing a five- or nine-digit number, ignoring the dash “-” that may be present in a nine-digit number, to a potential postal code. The monitoring circuit, routine or application 440 also identifies groups that contain content appearing up to three lines preceding the potential postal code within the user's current context, since these lines may represent the remaining part of an address. The monitoring circuit, routine or application 440 also determines whether a given group of characters corresponds to an email address. Any group comprising the “@” character is associated with a potential email address. In various exemplary embodiments, a group that contains other electronic address type information, such as “www”, “http”, “html” or the like is associated with a potential electronic address. The monitoring circuit, routine or application 440 also associates group containing any ten-digit number with a potential telephone number. The monitoring circuit, routine or application 440 then outputs all the groups that contain potential, postal codes, potential email or other electronic addresses and/or potential telephone numbers to the memory portion 432 as an analysis list.

The analyzing circuit, routine or application 450, under control of the controller 420, inputs the potential postal codes, email or other electronic addresses or telephone numbers of the analysis list from the memory portion 432. Then, the analyzing circuit, routine or application 450 compares group, whether that group contains a postal code, an email or other electronic address and/or a telephone number, present in the analysis list to postal codes, email and other electronic addresses and telephone numbers, respectively, present in the contact information data base, which is stored, for example, in the data source 500. The analyzing circuit, routine or application 450 then assigns scores to any matches identified between postal codes, email and other electronic addresses and telephone numbers present in the data source 500 and the postal codes, email and other electronic addresses and telephone numbers present in the group contained in the analysis list. The analyzing circuit, routine or application 450, if applicable, also combines the scores of interrelated postal codes, email and other electronic addresses or telephone numbers because, for example, they belong to the same person or entity and/or to a related person or entity. The analyzing circuit, routine or application, 450 under control of the controller 420, stores the scores or combined scores for each match, in the memory portion 434.

The ranking circuit, routine or application 460, under control of the controller 420, sorts the elements of the analysis list with respect to their respective scores from most relevant contact information (i.e., highest score) to least relevant contact information (i.e., lowest score). In various exemplary embodiments, the ranking circuit, routine or application 460, under control of the controller 420, then outputs the contact information associated with at least the n highest ranked groups, where n is any desired value, to the memory portion 435 as a display list of contact information that is appropriate to display to the user in view of the current context. In various other exemplary embodiments, the ranking circuit, routine or application 460, under control of the controller 420, then outputs the contact information associated with any group having a score that is greater than or equal to a defined threshold score to the memory portion 435 as the display list. In still other exemplary embodiments, the ranking circuit, routine or application 460, under control of the controller 420, then outputs the contact information associated with at most the top n groups that have a score that is greater than or equal to the defined threshold score to the memory portion 435 as the display list.

The list display portion generating circuit, routine or application 470, under control of the controller 420, inputs the display list from the memory portion 435. The list display portion generating circuit, routine or application 470 generates an unobtrusive list display portion structure or device, such as a toolbar or other graphical user interface widget, that contains selectable icons or some other appropriate elements for the contact information associated with the n highest ranked groups, and outputs the generated list display portion to the application manager 480, which is added by the application manager to the displayed information displayed by that application to the user, so that the display list portion is displayed to the user.

While this invention has been described in conjunction with the exemplary embodiments outlined above, various alternatives, modifications, variations, improvements, and/or substantial equivalents, whether known or that are or may be presently unforeseen, may become apparent to those having at least ordinary skill in the art. Accordingly, the exemplary embodiments of the invention, as set forth above, are intended to be illustrative, not limiting. Various changes may be made without departing from the spirit and scope of the invention. Therefore, the claims as filed and as they may be amended are intended to embrace all known or later-developed alternatives, modifications variations, improvements, and/or substantial equivalents.

1. A method for retrieving contact information based on a user's context, comprising:
monitoring the user's context to identify contact-related portions of the user's context;
analyzing the identified contact-related portions; and
retrieving zero, one or more contact information elements from a database based on the analyzed contact-related portions.

2. The method of claim 1, further comprising unobtrusively outputting at least one retrieved contact element.

3. The method of claim 1, wherein monitoring the user's context to identify contact-related portions of the user's context comprises:
converting the user's context to a plurality of searchable representation elements, each representing a potential contact-related portion; and
determining, for each searchable representation, if that searchable representation element is a contact-related portion.

4. The method of claim 3, wherein determining if a searchable representation element is a contact-related portion comprises determining if that searchable representation element is at least one of at least a postal code, an email address, a location on a network and a telephone number.

5. The method of claim 3, wherein analyzing the identified contact-related portions comprises:
comparing each identified contact-related portion of the plurality of searchable representation elements to contact information present in the contact information database;
determining, for each identified contact-related portion, if that contact-related portion matches any contact information elements of the contact information database;
assigning a score to each determined match between one of the identified contact-related portions and one of the contact information elements; and
determining, based on the assigned scores, for each match between the identified contact-related portions and the contact information elements, zero, one or more contact information elements that are related to the user's context.

6. The method of claim 5, wherein determining, based on the assigned scores, for each match between the identified contact-related portions and the contact information elements, zero, one or more contact information elements that are related to the user's context comprises comparing the assigned scores for each match to a threshold score value.

7. The method of claim 5, wherein assigning a score to each match between the identified contact-related portions and the contact information elements, comprises combining the scores assigned to at least two matches between at least two contact-related portions and at least one related contact information element into a combined score for at least one of the at least two matches.

8. The method of claim 5, wherein assigning a score to each match between the identified contact-related portions and the contact information elements comprises combining the scores assigned to at least two matches between at least one contact-related portion and at least two related contact information elements into a combined score for at least one of the at least two matches

9. The method of claim 5, where assigning a score to each match between the identified contact-related portions and the contact information elements comprises assigning a combined score to at least one of at least two interrelated matches.

10. The method of claim 5, further comprising ranking the contact information elements based on the scores assigned to the matches for the contact information elements.

11. The method of claim 5, further comprising forming a display list that includes contact information elements corresponding to scores above a defined threshold.

12. The method of claim 11, wherein forming the display list that includes contact information elements corresponding to scores above the defined threshold further comprises limiting the display list to at most n contact information elements having the highest values.

13. The method of claim 5, further comprising forming a display list that includes contact information elements corresponding to a given number n of scores having the highest values.

14. The method of claim 11, further comprising displaying the display list within the user's context.

15. The method of claim 1, wherein monitoring the user's context to identify contact-related portions of the user's context comprises:
determining at least one representation of at least one contact information element present in the database; and
determining, for each determined representation, if there is at least one contact-related portion in the user's current context that matches that determined representation.

16. The method of claim 15, wherein determining at least one representation of at least one contact information element present in the database comprises selecting at least one contact information element as the at least one determined representation.

17. The method of claim 16, wherein determining, for each determined representation, if there is at least one contact-related portion in the user's current context that matches that determined representation comprises searching the user's current context for instances of the selected contact information element.

18. The method of claim 15, wherein determining at least one representation of at least one contact information element present in the database comprises generating at least one regular expression from at least one contact information element as the at least one determined representation.

19. The method of claim 15, wherein determining, for each determined representation, if there is at least one contact-related portion in the user's current context that matches that determined representation comprises querying the user's current context using the at least one generated regular expression.

20. A method for inputting contact information into a contact information database comprising:
scanning a business card containing contact information elements;
making an audio recording of a contact;
making a video recording of a contact; and
inputting other contact information.

21. The method of claim 20, wherein the at least one contact information element comprises at least one of a postal code, an email address, a location on a network, an organization name and a telephone number.

22. An information retrieval system, comprising:
a database that stores contact information; and
a contact information retrieval system that retrieves contact information from the database based on a current context of a user and that unobtrusively displays the retrieved contact information relative to the user's current context.

23. The system of claim 22, wherein the database is populated by at least one of a personal name, an organization name, a position title, a business card image, a video recording, an audio recording, a postal address, a network location, an email address, and at least one telephone number.

24. The system of claim 22, wherein the contact information retrieval system comprises at least one of:
a context monitoring subsystem;
an information analysis subsystem; and
a contact information display subsystem.

25. The system of claim 24, wherein the context monitoring subsystem identifies contact information based on the content of the user's current context.

26. The system of claim 25, wherein the context monitoring subsystem recognizes at least one of a personal name, an organization name, a position title, a business card image, a video recording, an audio recording, a postal address, a network location, an email address, and at least one telephone number that is present in the content of the user's current context.

27. The system of claim 26, wherein the context monitoring subsystem recognizes the postal address by recognizing a postal code and stores in a memory the recognized postal code and a predetermined amount of data that precedes the postal code.

28. The system of claim 26, wherein the information analysis subsystem matches at least one recognized one of the personal name, the organization name, the position title, the business card image, the video recording, an audio recording, the postal address, the network location, the email address and the at least one telephone number to at least one contact information element stored in the database.

29. The system of claim 28, wherein the information analysis subsystem assigns a score to at least one matched one of the personal name, the organization name, the position title, the address, the network location, the email address and the at least one telephone number that matches at least one contact information element stored in the database.

30. The system of claim 28, wherein the information analysis subsystem assigns a partial score to at least one matched one of the personal name, the organization name, the position title, the address, the network location, the email address and the at least one telephone number that partially matches at least one contact information element stored in the database.

31. The system of claim 28, wherein the matched contact information is ranked based on the user's current context and output to the user.

32. The system of claim 31, wherein corollary information corresponding to the matched contact information is retrieved from the database.

33. The system of claim 32, wherein the matched contact information and the corollary information are made available to the user.

34. The system of claim 22, wherein the user is provided with an unobtrusive notification of the retrieved contact information.

35. The system of claim 34, wherein the notification allows the user to access more contact information by a single interaction.

36. An information retrieval apparatus, comprising:
a database containing contact information;
an information gathering device that inputs contact information into the database;
an information monitoring device that monitors a user's current context to identify potential contact information;
an information analysis device that assigns a score to the identified potential contact information; and
a data output device that notifies a user of zero, one or more contacts based on scores associated with the potential contact information.

37. The apparatus of claim 36, wherein the information gathering device is at least one of a workstation, a desktop computer, a laptop computer, a scanner, an audio/video recorder, and a remote station.

38. The apparatus of claim 36, wherein the data output device unobtrusively notifies the user of one or more contacts.
